(19) United States
(12) Patent Application Publication
(10) Pub. No.: US 2012/0120505 A1
(43) Pub. Date: May 17, 2012

(54) WIDE ANGLE LENS

(75) Inventors: Seigou NAKAI, Saitama (JP); Lai Wei, Saitama (JP)

(73) Assignee: TAMRON CO., LTD.

(21) Appl. No.: 13/222,440

(22) Filed: Aug. 31, 2011

(30) Foreign Application Priority Data
Nov. 17, 2010 (JP) 2010-256885

(51) Int. Cl. G02B 13/18; G02B 9/10

(52) U.S. Cl. 359/717; 359/793

(57) ABSTRACT

A wide angle lens includes sequentially from the object side, a first lens group having a negative refractive power; an aperture stop; and a second lens group having a positive refractive power, where the first lens group includes sequentially from the object side, a negative first lens having on the object side, a convex surface; a negative second lens having on the image side, a concave surface; a negative third lens; and a positive fourth lens. The second lens group includes sequentially from the object side a cemented lens having a positive refractive power and formed by a fifth lens and a sixth lens; a positive seventh lens; and a negative eighth lens having on the image side, a concave surface.

### BACKGROUND OF THE INVENTION

1. Field of the Invention

The present invention relates to a wide angle lens suitable for electronic imaging apparatuses equipped with an imaging device such as a charge couple device (CCD) and a complementary metal oxide semiconductor (CMOS).

2. Description of the Related Art

As an imaging lens for monitoring cameras, a wide angle lens is known that has a diaphragm at a border and from an object side toward an image side of the imaging lens, includes a front group of lenses and a rear group of lenses (see, for example, Japanese Patent Application Laid-Open Publication No. 2004-102162).

The wide angle lens disclosed in Japanese Patent Application Laid-Open Publication No. 2004-102162 includes sequentially from the object side, the negative front group; an aperture stop; and the positive rear group, where the front group is formed by four lenses that include sequentially from the object side, three negative lenses having a concave surface facing toward the image and one positive lens, and the rear group is a single positive lens.

With respect to imaging lenses used in monitoring cameras, to establish a favorable field of view over a wide range without the occurrence of blind spots, high imaging performance over the entire effective imaging area is demanded in addition to a wide angle view. Imaging lenses for monitoring cameras are further expected to be bright lenses since monitoring cameras are also used at night. Furthermore, consequent to size reductions of imaging apparatuses, the angle of incidence of the chief ray to the imaging device becomes large and the suppression of drops in the amount of peripheral light is demanded. However, neither the wide angle lens recited in Japanese Patent Application Laid-Open Publication No. 2004-102162 nor other conventional wide angle lens satisfy these demands.

For example, although the wide angle lens recited in Japanese Patent Application Laid-Open Publication No. 2004-102162 has an angle of view on the order of 170 degrees and thereby satisfies the condition of a wide angle view, the wide angle lens does not sufficiently correct chromatic aberration of magnification and thus, achieving high imaging performance is difficult. Furthermore, since the wide angle lens has an F value of 2.3, image brightness, particularly at night, is not sufficiently achieved, which is not desirable of an imaging lens for a monitoring camera.

### SUMMARY OF THE INVENTION

It is an object of the present invention to at least solve the above problems in the conventional technologies.

A wide angle lens according to one aspect of the present invention includes sequentially from an object side, a first lens group having a negative refractive power; an aperture stop; and a second lens group having a positive refractive power. The first lens group includes four or more lenses, and the second lens group includes four or more lenses, among which the lens farthest on an image side of the second lens group is a negative lens.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross sectional view (along the optical axis) of a wide angle lens according to a first example;

FIG. 2 is a schematic of spherical aberration of the wide angle lens according to the first example;

FIG. 3 is a schematic of chromatic aberration of magnification of the wide angle lens according to the first example;

FIG. 4 is a schematic of coma aberration of the wide angle lens according to the first example;

FIG. 5 is a cross sectional view (along the optical axis) of the wide angle lens according to a second example;

FIG. 6 is a schematic of spherical aberration of the wide angle lens according to the second example;

FIG. 7 is a schematic of chromatic aberration of magnification of the wide angle lens according to the second example;

FIG. 8 is a schematic of coma aberration of the wide angle lens according to the second example;

FIG. 9 is a cross sectional view (along the optical axis) of the wide angle lens according to a third example;

FIG. 10 is a schematic of spherical aberration of the wide angle lens according to the third example;

FIG. 11 is a schematic of chromatic aberration of magnification of the wide angle lens according to the third example; and

FIG. 12 is a schematic of coma aberration of the wide angle lens according to the third example.

### DETAILED DESCRIPTION OF THE PREFERRED EMBODIMENTS

Referring to the accompanying drawings, exemplary embodiments according to the present invention are explained in detail below.

The wide angle lens according to the present invention includes sequentially from the object side of the wide angle lens, a first lens group that has a negative refractive power, an aperture stop, and a second lens group that has a positive refractive power. The first lens group includes four or more lenses, the second lens group includes four or more lenses, among which the lens farthest on the image side is a negative lens. By such configuration, chromatic aberration of magnification and coma aberration can be favorably corrected. In particular, since the wide angle lens is configured by 8 or more lenses, coma aberration that occurs with 7 or fewer lenses consequent to the surface radius of curvature becoming small and the occurrence of chromatic aberration of magnification that cannot be corrected at the peripheral image height, can be effectively suppressed.

In the second lens group, by disposing the concave surface of the negative lens farthest on the image side to face toward the image side, light beam vignetting occurring at the peripheral image height is reduced and drops in the amount of peripheral light can be suppressed. Further, in the second lens group, by disposing a positive lens as the lens second farthest on the imaging side, the chromatic aberration of magnification and the coma aberration associated with the second farthest positive lens on the image side and with the farthest negative lens on the image side, balance out, enabling the occurrence of chromatic aberration of magnification and of coma aberration to be more effectively suppressed.

With consideration of the characteristics above, if other types of aberration (e.g., spherical aberration, etc.) are to be corrected more effectively, the wide angle lens according to the present invention may be configured as follows. For example, configuration may be such that the wide angle lens includes sequentially from the object side, a first lens group that has a negative refractive power, an aperture stop, and a second lens group that has a positive refractive power, where the first lens group includes sequentially from the object side, a negative first lens having on the object side thereof, a convex surface; a negative second lens having on the image side thereof, a concave surface; a negative third lens; and a positive fourth lens. Furthermore, the second lens group includes sequentially from the object side, a cemented lens having a positive refractive power and formed by a fifth lens and a sixth lens, a positive seventh lens, and a negative eighth lens having on the image side thereof, a concave surface. In this manner, by including the cemented lens, chromatic aberration of magnification and coma aberration as well as other types of aberration such as axial chromatic aberration can be favorably corrected. Additionally, by forming the second lens and the eighth lens to have an aspheric surface, spherical aberration and coma aberration can be expected to be corrected yet more favorably.

An object of the present invention is to provide a compact wide angle lens that in addition to bright, wide angle images, provides high imaging performance over the entire effective imaging area, enabling use in monitoring cameras. To achieve this object, the following conditions are set.

The wide angle lens according to the present invention preferably satisfies the following conditional expressions where, the Abbe number at the d-line of the lens farthest on the image side is AB1 and the Abbe number at the d-line of the second farthest lens on the image side is AB2.

AB1<AB2 (1)

AB1<45 (2)

In this manner, by setting the Abbe number at the d-line of the lens farthest on the image side to be less than the Abbe number at the d-line of the second farthest lens, the occurrence of chromatic aberration of magnification and of coma aberration at the peripheral height, in particular a problem of wide angle lenses, can be effectively suppressed. If the Abbe number at the d-line of the farthest lens is 45 or greater, the occurrence of chromatic aberration of magnification and coma aberration at the peripheral image height cannot be suppressed.

The wide angle lens according to the invention may adopt the following configuration to suppress the occurrence of chromatic aberration of magnification and coma aberration at the peripheral image height. In other words, the wide angle lens includes sequentially from the object side, a first lens group that has negative refractive power, an aperture stop, and a second lens group that has a positive refractive power, where the first lens group includes four or more lenses and the second lens group includes four or more lenses, among which the surface on the image side of the lens farthest on the image side is aspheric and satisfies the following conditional expression.

$$\begin{matrix} X ( 0.7 H ) > 0 \\ Where , & ( 3 ) \\ X = \frac{{H}^{2} / R}{1 + \sqrt{1 - ( ɛ {H}^{2} / {R}^{2} )}} + {AH}^{2} + {BH}^{3} + {CH}^{4} + {DH}^{5} + {EH}^{6} + {FH}^{7} + {GH}^{8} + {IH}^{9} + {JH}^{10} + {KH}^{11} + {LH}^{12} + {MH}^{13} & [ 1 ]\end{matrix}$$

X is the sag (direction of image plane assumed as positive) of the aspheric surface shape from the intersection with the optical axis; H is the distance from the optical axis toward the outer diameter of lens; R is paraxial radius of curvature; ε is the constant of the cone; A, B, C, D, E, F, G, J, K, L, and M are the second, third, fourth, fifth, sixth, seventh, eighth, ninth, tenth, eleventh, twelfth, and thirteenth aspheric coefficients, respectively; and X(0.7H) represents aspheric surface shape sag at a position 70% of the distance H from the optical axis center with respect to the effective diameter of the surface on the image side of the lens farthest on the image side.

The reason for considering aspheric surface shape sag at a position 70% of the distance H from the optical center with respect to the effective diameter of the surface on the image side of the lens farthest on the image side among the lenses of the second lens group is because sag at that position indicates high optical convergence efficiency at the imaging device for light that passes through that position of the lens.

Since sensitivity for incident light entering at an angle is low for imaging devices such as CCDs and CMOSs compared to silver halide films, the chief ray angle (CRA), which is the incident angle of light entering the imaging device, is demanded to be small. Meanwhile, in recent years, consequent to the desire for image apparatus size reduction, the overall length of the optical system is also demanded to be reduced and the sensitivity of imaging devices with respect to incident light entering at an angle has to be improved. Hence, recently, mainstream imaging devices have the recommended 15 to 30-degree CRA for imaging devices. Further, at the light receiving surface (imaging surface) of the imaging device, the position at 70% of the maximum image height is where the optical convergence efficiency is most optimal.

Hence, the wide angle lens according to the present invention preferably satisfies the following conditional expression, where the incident angle of the chief ray to the imaging surface, forming the image at a position 70% of the maximum image height Iₘₐₓ is θ (0.7Iₘₐₓ).

15<θ(0.7Iₘₐₓ)<30 (4)

Satisfaction of conditional expression (4) enables reduction of the vignetting of the light beam forming the image at the peripheral image height and suppression of drops in the amount of peripheral light. Here, beyond the upper limit of and below the lower limit of conditional expression (4), vignetting occurs at a portion of the light beam forming the peripheral image height, inviting drops in the amount of peripheral light to occur.

As described, the wide angle lens according to the present invention has the characteristics described above, whereby in addition to a bright, wide angle image, high imaging performance over the entire effective imaging area can be obtained. In other words, by incorporating the above characteristics, a compact, wide angle lens suitable for monitoring cameras can be provided, e.g., a wide angle lens having an F number on the order of 1.7, an angle of view of 200 or more degrees, and excellent imaging performance, enabling effective chromatic aberration correction out to the periphery of the image.

With reference to the accompanying drawings, examples of the wide angle lens according to the present invention will be described in detail. The invention is not limited by the examples below.

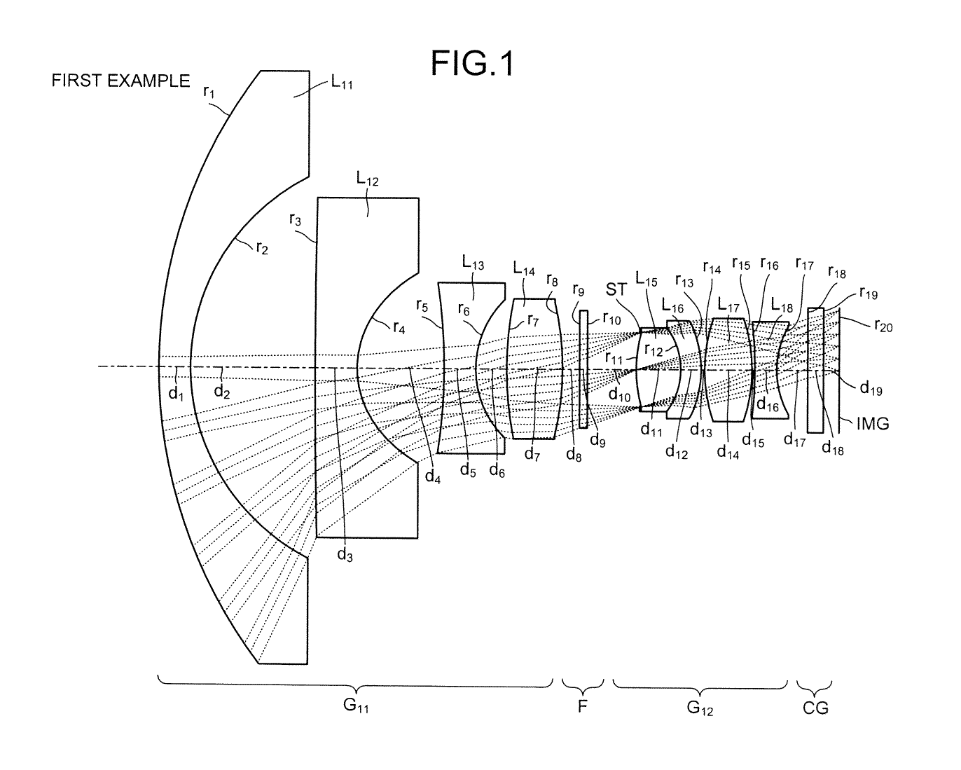

FIG. 1 is a cross sectional view (along the optical axis) of the wide angle lens according to a first example. The wide angle lens includes sequentially from the object side (object not depicted), a first lens group G₁₁ having a negative refractive power, an aperture stop ST prescribing a given aperture, and a second lens group G₁₂ having a positive refractive power. In the wide angle lens, an IR-cut filter F that blocks infrared rays is disposed between the first lens group G₁₁ and the aperture stop ST; and a color glass CG is disposed between the second lens group G₁₂ and the imaging plane IMG. The IR-cut filter and the color glass CG are disposed as necessary and can be omitted. At the imaging plane IMG, the optical receiving surface of the imaging device, such as a CCD and CMOS, is disposed.

The first lens group G₁₁ includes sequentially from the object side, a negative first lens L₁₁ having on the object side thereof, a convex surface; a negative second lens L₁₂ having on the imaging plane IMG side thereof, a concave surface; a negative third lens L₁₃; and a positive fourth lens L₁₄. Furthermore, both surfaces of the second lens L₁₂ are aspheric.

The second lens group G₁₂ includes sequentially from the object side, a cemented lens having a positive refractive power and formed by a fifth lens L₁₅ and a sixth lens L₁₆; a positive seventh lens L₁₇; and a negative eighth lens L₁₈ having on the imaging plane IMG thereof, a concave surface. The aperture stop ST is disposed at the fifth lens L₁₅, at the surface thereof on the object side. Both surfaces of the seventh lens L₁₇ and of the eighth lens L₁₈ are aspheric.

Various values related to the wide angle lens according to the first example are indicated below.

Focal length of entire wide angle lens system=1.10 (mm)
F value=1.70
Maximum field of view=208°
Maximum image height (Iₘₐₓ)=(2.0 mm)
(Values related to conditional expressions (1) and (2))

### AB1=25.6, AB2=56.0

### (AB1<AB2, AB1<45)

(Values related to conditional expression (3))

### X(0.7H)=0.176(>0)

Effective diameter of eighth lens L₁₈:φ2.9
(Values related to conditional expression (4))

### (15<)θ(0.7Iₘₐₓ)=19.4°(<30)

r₁=15.9327
d₁=0.9971 nd₁=0.8830 υd₁=40.8
   r₂=6.9238
d₂=3.9810
   r₃=146.0847 (aspheric surface)
d₃=1.3388 nd₂=1.5312 υd₂=56.0
   r₄=3.2097 (aspheric surface)
d₄=2.7843
   r₅=−17.3963
d₅=1.0190 nd₃=1.4875 υd₃=70.2
   r₆=3.0841
d₆=0.9921
   r₇=10.8096
d₇=1.8017 nd₄=2.0007 υd₄=25.5
   r₈=−9.6129
d₈=0.5500
   r₉=∞
d₉=0.2500 nd₅=1.5163 υd₅=64.1
   r₁₀=∞
d₁₀=1.5866
   r₁₁=4.5388
d₁₁=1.4277 nd₆=1.4970 υd₆=81.5
   r₁₂=−2.1860
d₁₂=0.6605 nd₇=1.9459 υd₇=18.0
   r₁₃=−3.3032
d₁₃=0.1000
   r₁₄=4.7836 (aspheric surface)
d₁₄=1.5165 nd₈=1.5312 υd₈=56.0
   r₁₅=−3.5486 (aspheric surface)
d₁₅=0.1000
   r₁₆=−17.1750 (aspheric surface)
d₁₆=0.6871 nd₉=1.6142 υd₉=25.6
   r₁₇=2.9857 (aspheric surface)
d₁₇=1.0000
   r₁₈=∞
d₁₈=0.5000 nd₁₀=1.5163 υd₁₀=64.1
   r₁₉=∞
d₁₉=0.5050
   r₂₀=∞ (imaging plane)
   Constant of the cone (ε) and aspheric coefficients (A, B, C, D, E, F, G, I, J, K, L, M)
   (third plane)
   ε=−26.7977,

### A=0, B=0,

### C=1.6735×10⁻⁴, D=0,

### E=−1.4609×10⁻⁵, F=0,

### G=3.2201×10⁻⁷, I=0,

### J=−2.2695×10⁻⁹, K=0,

### L=0, M=0

(fourth plane)
ε=−3.4148,

### A=0, B=0,

### C=1.5835×10⁻², D=0,

### E=−1.1387×10⁻³, F=0,

### G=1.3770×10⁻⁴, I=0,

### J=−7.4376×10⁻⁶, K=0,

### L=0, M=0

(fourteenth plane)
ε=−42.2987,

### A=0, B=1.4812×10⁻²,

### C=2.5477×10⁻², D-2.2023×10⁻³,

### E=−1.2630×10⁻², F=−1.5868×10⁻⁴,

### G=6.1562×10⁻³, I=−1.4662×10⁻³,

### J=−9.4876×10⁻⁴, K=4.9961×10⁻⁵,

### L=3.3281×10⁻⁴, M=−9.3351×10⁻⁵

(fifteenth plane)

### E=−0.9944,

### A=0, B=3.7469×10⁻²

### C=−1.1746×10⁻², D=4.3306×10⁻³

### E=2.4489×10⁻⁴, F=−1.3142×10⁻³

### G=−7.9739×10⁻⁴, I=−8.0732×10⁻⁵,

### J=2.4372×10⁻⁴, K=2.1606×10⁻⁴,

### L=2.6246×10⁻⁵, M=−6.2389×10⁻⁵

(sixteenth plane)
ε=60.7114,

### A=0, B=7.6637×10⁻³

### C=7.8958×10⁻³, D=−1.1692×10⁻²,

### E=—2.7694×10⁻³, F=6.3880×10⁻⁴,

### G=8.5334×10⁻⁴, I=8.2667×10⁻³,

### J=−2.4691×10⁻³, K=−8.6688×10⁻³,

### L=7.0636×10⁻³, M=−1.5798×10⁻³

(seventeenth plane)
ε=−7.8466,

### A=0, B=2.8982×10⁻²,

### C=−3.2293×10⁻², D=4.3727×10⁻²

### E=−1.1298×10⁻², F=−1.9521×10⁻³,

### G=2.1547×10⁻³, I=3.7162×10⁻⁴,

### J=−2.8823×10⁻⁴, K=1.0327×10⁻⁴

### L=8.7945×10⁻⁵, M=−6.6464×10⁻⁵

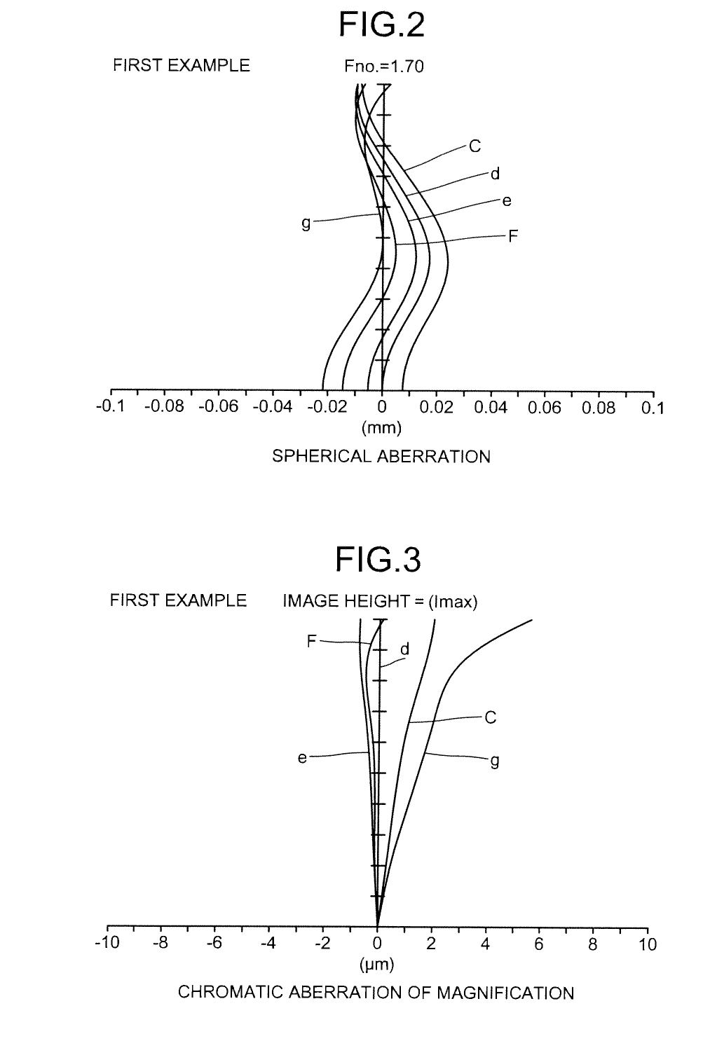

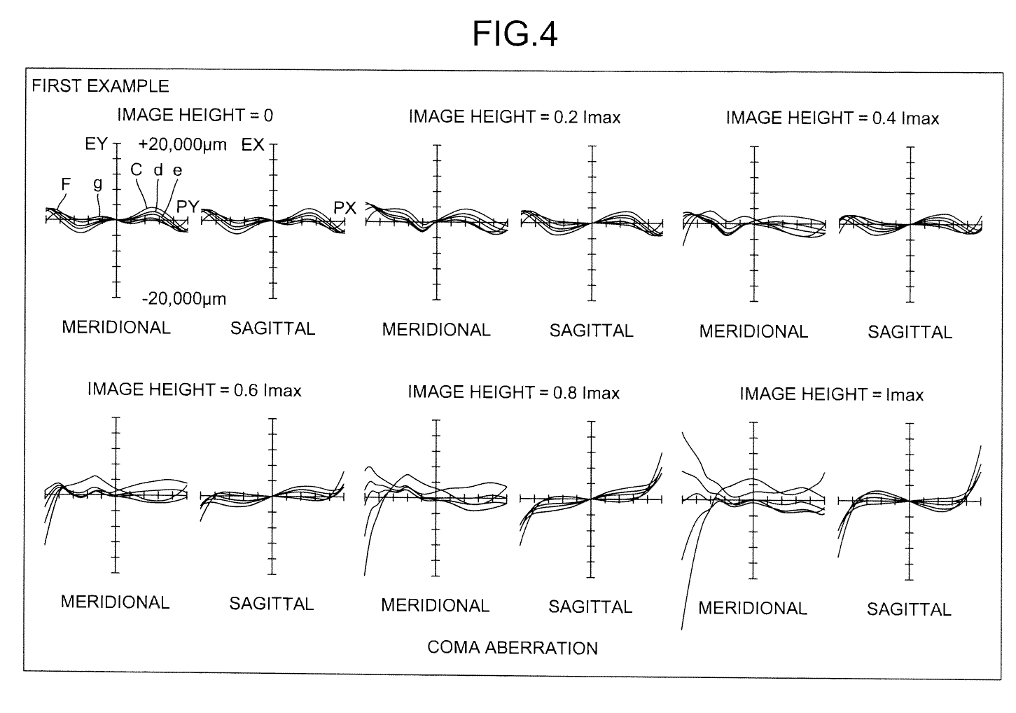

FIG. 2 is a schematic of spherical aberration of the wide angle lens according to the first example. FIG. 3 is a schematic of chromatic aberration of magnification of the wide angle lens according to the first example. FIG. 4 is a schematic of coma aberration of the wide angle lens according to the first example. In the schematics, d indicates wavelength aberration corresponding to the d-line (λ=588 nm), g indicates wavelength aberration corresponding to the g-line (λ=436 nm), F indicates wavelength aberration corresponding to the F-line (λ=486 nm), C indicates wavelength aberration corresponding to the C-line (λ=656 nm), and e indicates wavelength aberration corresponding to the e-line (λ=546 nm). Iₘₐₓ in the schematics of chromatic aberration of magnification and coma aberration represents the maximum image height.

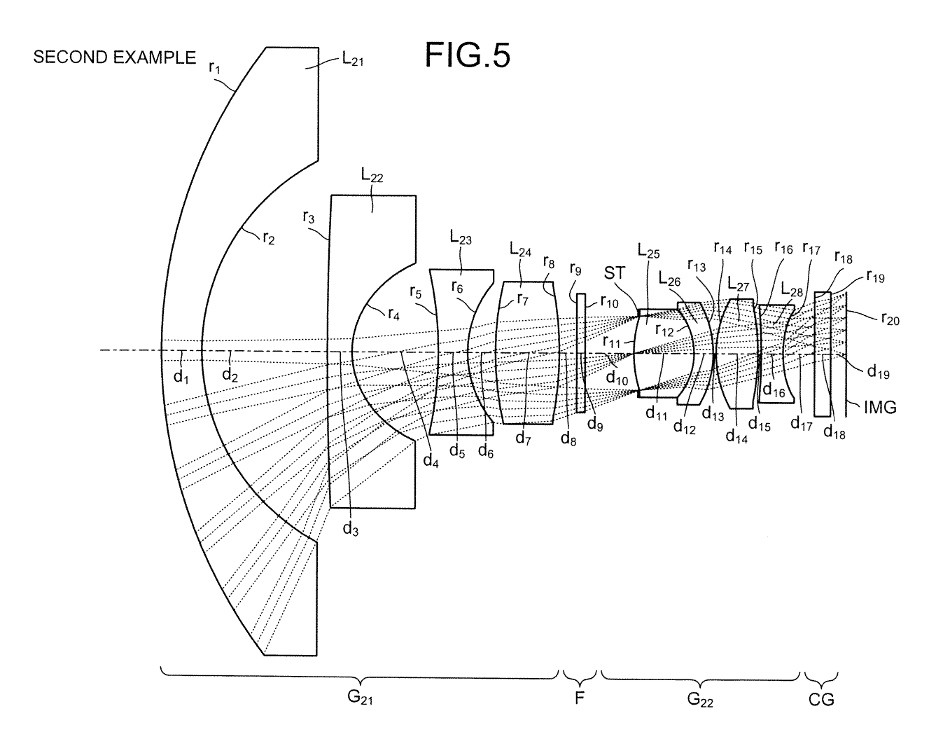

FIG. 5 is a cross sectional view (along the optical axis) of the wide angle lens according to a second example. The wide angle lens includes sequentially from the object side (object not depicted), a first lens group G₂₁ having a negative refractive power, the aperture stop ST prescribing a given aperture, and a second lens group G₂₂ having a positive refractive power. In the wide angle lens, the IR-cut filter, which blocks infrared rays, is disposed between the first lens group G₂₁ and the aperture stop ST; and the color glass CG is disposed between the second lens group G₂₂ and the imaging plane IMG. The IR-cut filter and the color glass CG are disposed as necessary and can be omitted. At the imaging plane IMG, the optical receiving surface of the imaging device, such as a CCD and a CMOS, is disposed.

The first lens group G₂₁ includes sequentially from the object side, a negative first lens L₂₁ having on the object side thereof, a convex surface; a negative second lens L₂₂ having on the imaging plane IMG side thereof, a concave surface; a negative third lens L₂₃; and a positive fourth lens L₂₄. Furthermore, both surfaces of the second lens L₂₂ are aspheric.

The second lens group G₂₂ includes sequentially from the object side, a cemented lens having a positive refractive power and formed by a fifth lens L₂₅ and a sixth lens L₂₆; a positive seventh lens L₂₇; and a negative eighth lens L₂₈ having on the image plane IMG side thereof, a concave surface. The aperture stop ST is disposed at the fifth lens L₂₅, at the surface on the object side. Both surfaces of the eighth lens L₂₈ are aspheric.

Various values related to the wide angle lens according to the second example are indicated below.

Focal length of entire wide angle lens system=1.10 (mm)
F value=1.70
Maximum field of view=206°
Maximum image height (Iₘₐₓ)=(2.0 mm)
(Values related to conditional expressions (1) and (2))

### AB1=40.7, AB2=61.1

### (AB1<AB2, AB1<45)

(Values related to conditional expression (3))

### X(0.7H)=0.155(>0)

Effective diameter of eighth lens L₂₈:φ2.9
(Values related to conditional expression (4))

### (15<)θ(0.7Iₘₐₓ)=19.2°(<30)

r₁=16.0864
d₁=1.2907 nd₄=1.8830 υd₄=40.8
   r₂=6.9416
d₂=3.9838
   r₃=113.0652 (aspheric surface)
d₃=0.7846 nd₂=1.5312 υd₂=56.0
   r₄=2.8449 (aspheric surface)
d₄=2.7591
   r₅=−12.5199
d₅=0.9430 nd₃=1.4875 υd₃=70.2
   r₆=3.4817
d₆=0.8955
   r₇=10.2345
d₇=2.0614 nd₄=2.0007 υd₄=25.5
   r₈=−10.4381
d₈=0.5500
   r₉=∞
d₉=0.2500 nd₅=1.5163 υd₅=64.1
   r₁₀=∞
d₁₀=1.5866
   r₁₁=4.2276
d₁₁=1.9169 nd₆=1.4970 υd₆=81.5
   r₁₂=2.1540
d₁₃=0.6141 nd₇=1.9459 υd₇=18.0
   r₁₃=−3.3389
d₁₃=0.1000
   r₁₄=3.5849
d₁₄=1.3275 nd₈=1.5891 υd₈=61.1
   r₁₅=−8.1241
d₁₅=0.1000
   r₁₆=−51.7825 (aspheric surface)
d₁₆=0.6980 nd₉=1.8061 υd₉=40.7
   r₁₇=3.8023 (aspheric surface)
d₁₇=1.0000
   r₁₈=∞
d₁₈=0.5000 nd₁₀=1.5163 υd₁₀=64.1
   r₁₉=∞
d₁₉=0.5043
   r₂₀=∞ (imaging plane)
   Constant of the cone (c) and aspheric coefficients (A, B, C, D, E, F, G, I, J, K, L, M)
   (third plane)
   ε=99.6419,

### A=0, B=0,

### C=1.5107×10⁻⁴, D=0,

### E=−1.3770×10⁻⁵, F=0,

### G=3.5764×10⁻⁷, I=0,

### J=−3.0079×10⁻⁹, K=0,

### L=0, M=0

(fourth plane)
ε=−2.0093,

### A=0, B=0,

### C=1.6071×10⁻², D=0,

### E=−1.0412×10⁻³, F=0,

### G=1.5623×10⁻⁴, I=0,

### J=−6.3069×10⁻⁶, K=0,

### L=0, M=0

(sixteenth plane)
ε=101.0000,

### A=0, B=−1.1310×10⁻³

### C=4.4931×10⁻³, D=−1.0623×10⁻²,

### E=−2.0042×10⁻³, F=6.9806×10⁻⁴,

### G=6.4696×10⁻⁴, I=8.0605×10⁻³,

### J=−2.5937×10⁻³, K=−8.7148×10⁻³,

### L=7.0707×10⁻³, M=−1.5438×10⁻³

(seventeenth plane)
ε=−4.8150,

### A=0, B=2.4057×10⁻²,

### C=−2.8960×10⁻², D=4.5268×10⁻²,

### E=−1.1796×10⁻², F=−2.8121×10⁻³,

### G=1.7027×10⁻³, I=2.8817×10⁻⁴,

### J=−2.2285×10⁻⁴, K=1.7935×10⁻⁴,

### L=1.1967×10⁻⁴, M=−8.7064×10⁻⁵

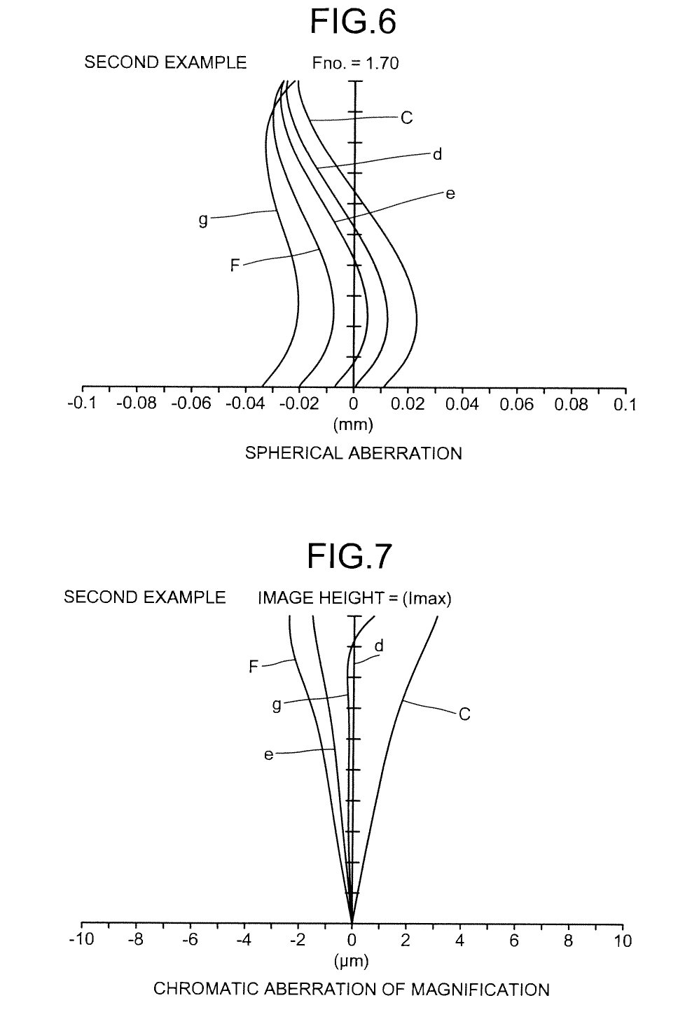

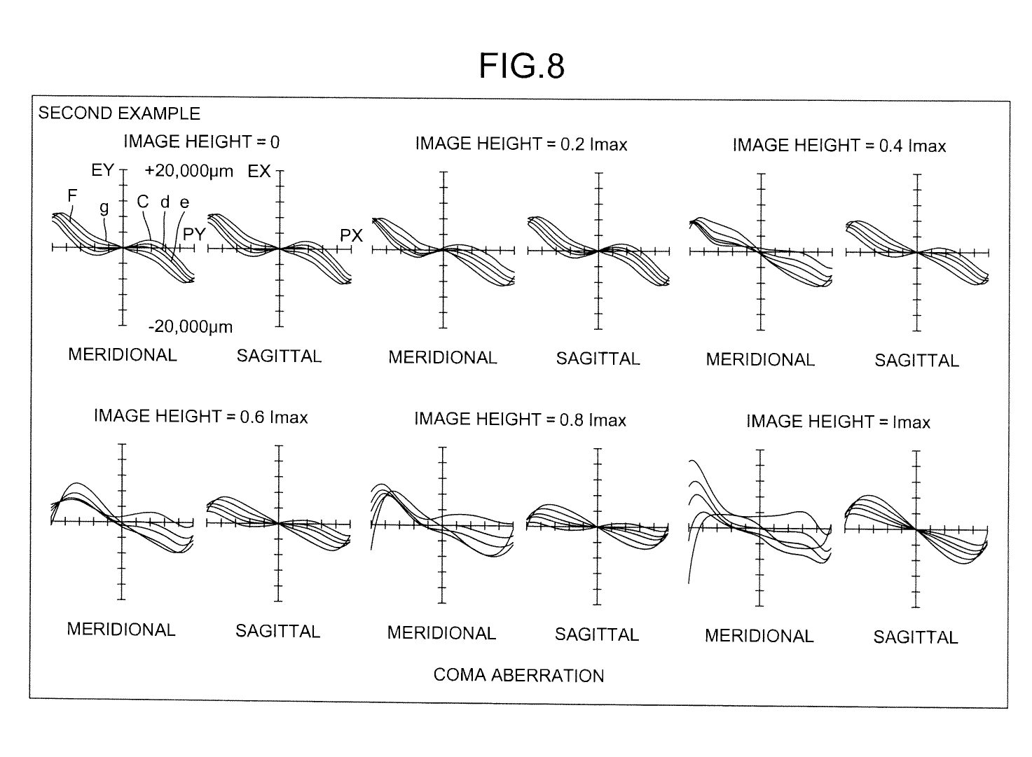

FIG. 6 is a schematic of spherical aberration of the wide angle lens according to the second example. FIG. 7 is a schematic of chromatic aberration of magnification of the wide angle lens according to the second example. FIG. 8 is a schematic of coma aberration of the wide angle lens according to the second example. In the schematics, d indicates wavelength aberration corresponding to the d-line the d-line (λ=588 nm), g indicates wavelength aberration corresponding to the g-line (λ=436 nm), F indicates wavelength aberration corresponding to the F-line (λ=486 nm), C indicates wavelength aberration corresponding to the C-line (λ=656 nm), and e indicates wavelength aberration corresponding to the e-line (λ=546 nm). Iₘₐₓ in the schematics of chromatic aberration of magnification and coma aberration represents the maximum image height.

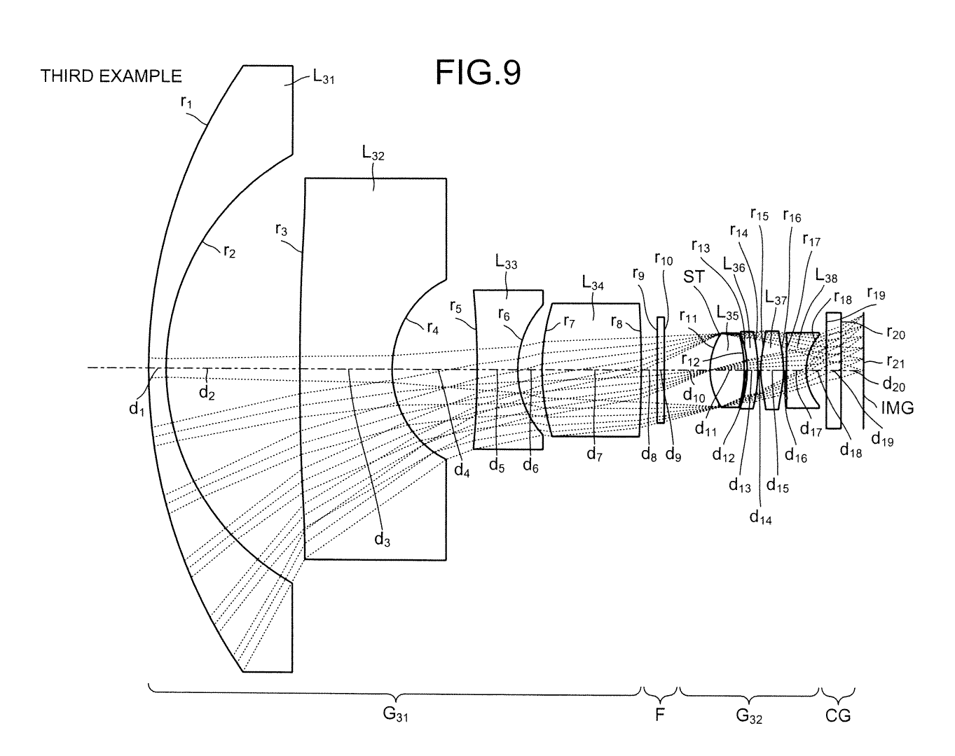

FIG. 9 is a cross sectional view (along the optical axis) of the wide angle lens according to a third example. The wide angle lens includes sequentially from the object side (object not depicted), a first lens group G₃₁ having a negative refractive power, the aperture stop ST prescribing a given aperture, and a second lens group G₃₂ having a positive refractive power. In the wide angle lens, the IR-cut filter, which blocks infrared rays, is disposed between the first lens group G₃₁ and the aperture stop ST; and the color glass CG is disposed between the second lens group G₃₂ and the imaging plane IMG. The IR-cut filter and the color glass CG are disposed as necessary and can be omitted. At the imaging plane IMG, the optical receiving surface of the imaging device, such as a CCD and a CMOS, is disposed.

The first lens group G₃₁ includes sequentially from the object side, a negative first lens L₃₁ having on the object side thereof, a convex surface; a negative second lens L₃₂ having on the imaging plane IMG side thereof, a concave surface; a negative third lens L₃₃; and a positive fourth lens L₃₄. Furthermore, both surfaces of the second lens L₃₂ are aspheric.

The second lens group G₃₂ includes sequentially from the object side, a positive fifth lens L₃₅, a negative sixth lens L₃₆, a positive seventh lens L₃₇, and a negative eighth lens L₃₈ having on the imaging plane IMG side thereof, a concave surface. The aperture stop ST is disposed at the fifth lens L₃₅, at the surface on the object side. Both surfaces of the seventh lens L₃₇ and of the eighth lens L₃₈ are aspheric.

Various values related to the wide angle lens according to the third example are indicated below.

Focal length of entire wide angle lens system=1.10 (mm)
F value=1.70
Maximum field of view=208°
Maximum image height (Iₘₐₓ)=(2.0 mm)
(Values related to conditional expressions (1) and (2))

### AB1=25.6, AB2=56.0

### (AB1<AB2, AB1<45)

(Values related to conditional expression (3))

### X(0.7H)=0.229(>0)

Effective diameter of eighth lens L₃₈:φ42.5
(Values related to conditional expression (4))

### (15<)θ(0.7Iₘₐₓ)=25.2(<30)

r₃=18.7525
d₁=0.6050 nd₁=2.0007 υd₁=25.5
   r₂=8.5669
d=4.5832
   r₃=117.4777 (aspheric surface)
d₃=3.1811 nd₂=1.5312 υd₂=56.0
   =3.7106 (aspheric surface)
d₄=2.9503
   r₅=−31.9403
d₅=1.4109 nd₃=1.4875 υd₃=70.2
   r₅=3.3487
d₆=0.8330
   r₇=7.4273
d₇=3.4569 nd₄=2.0007 υd₄=25.5
   r₈=−33.9559
d₈=0.5500
   r₉=∞
d₉=0.2500 nd₅=1.5163 υd₅=64.1
   r₁₀=∞
d₁₀=1.5866
   r₁₁=2.3644
d₁₁=1.1733 nd₅=1.4970 υd₆=81.5
   r₁₂=−4.3520
d₁₂=0.1000
   r₁₃=−3.5869
d₁₃=0.3765 nd₇=1.9459 υd₇=18.0
   r₁₄=−5.3784
d₁₄=0.1000
   r₁₅=3.8210 (aspheric surface)
d₁₅=0.7794 nd₈=1.5312 υd₈=56.0
   r₁₆=−3.8118 (aspheric surface)
d₁₆=0.1000
   r₁₇=103.6975 (aspheric surface)
d₁₇=0.6683 nd₉=1.6142 υd₅=25.6
   r₁₈=1.7610 (aspheric surface)
d₁₈=1.0000
   r₁₉=∞
d₁₉=0.5000 nd₁₀=1.5163 υd₁₀=64.1
   r₂₀=∞
d₂₀=0.4838
   r₂₁=∞ (imaging plane)
   Constant of the cone (ε) and aspheric coefficients (A, B, C, D, E, F, G, I, J, K, L, M)
   (third plane)
   ε=95.4025,

### A=0, B=0,

### C=3.2890×10⁻⁴, D=0,

### E=−1.6498×10⁵, F=0,

### G=2.7053×10⁻⁷, I=0,

### J=−1.5834×10⁻⁹, K=0,

### L=0, M=0

(fourth plane)

### A=0, B=0,

### C=1.6579×10⁻², D=0,

### E=−1.3525×10⁻³, F=0,

### G=1.1776×10⁻⁴, I=0,

### J=−3.1303×10⁻⁶, K=0,

### L=0, M=0

(fifteenth plane)
ε=−33.3867,

### A=0, B=1.5154×10⁻²,

### C=2.5687×10⁻², D=−7.4380×10⁻³,

### E=−1.7304×10⁻², F=−2.1626×10⁻³,

### G=5.8588×10⁻³, I=−1.1445×10⁻³,

### J=−5.7142×10⁻⁴, K=2.9325×10⁻⁴,

### L=4.1723×10⁻⁴, M=−1.3729×10⁻⁴

(sixteenth plane)
ε=−1.8031,

### A=0, B=3.6717×10⁻²,

### C=−1.0484×10⁻², D=−1.5705×10⁻³,

### E=−2.6041×10⁻³, F=−1.4692×10⁻³,

### G=−2.2574×10⁻⁴, I=3.2647×10⁻⁴,

### J=3.9671×10⁻⁴, K=2.5125×10⁻⁴,

### L=8.4350×10⁻⁵, M=8.9346×10⁻⁵

(seventeenth plane)
ε=35.5853,

### A=0, B=1.7102×10⁻²,

### C=4.9636×10⁻³, D=−1.3418×10⁻²,

### E=−5.7067×10⁻³, F=−2.1978×10⁻³,

### G=−4.6552×10⁻⁴, I=8.3036×10⁻³,

### J=−1.8104×10⁻³, K=−8.0437×10⁻³,

### L=7.2854×10⁻³, M=−1.8702×10⁻³

(eighteenth plane)
ε=−2.1645,

### A=0, B=3.4346×10⁻²,

### C=−1.7062×10⁻², D=6.6114×10⁻²,

### E=−1.6427×10⁻², F=−1.2737×10⁻²,

### G=−2.2270×10⁻³, I=8.2207×10⁻⁴,

### J=1.5173×10⁻³, K=1.2868×10⁻³,

### L=2.6324×10⁻⁴, M=−5.3397×10⁻⁴

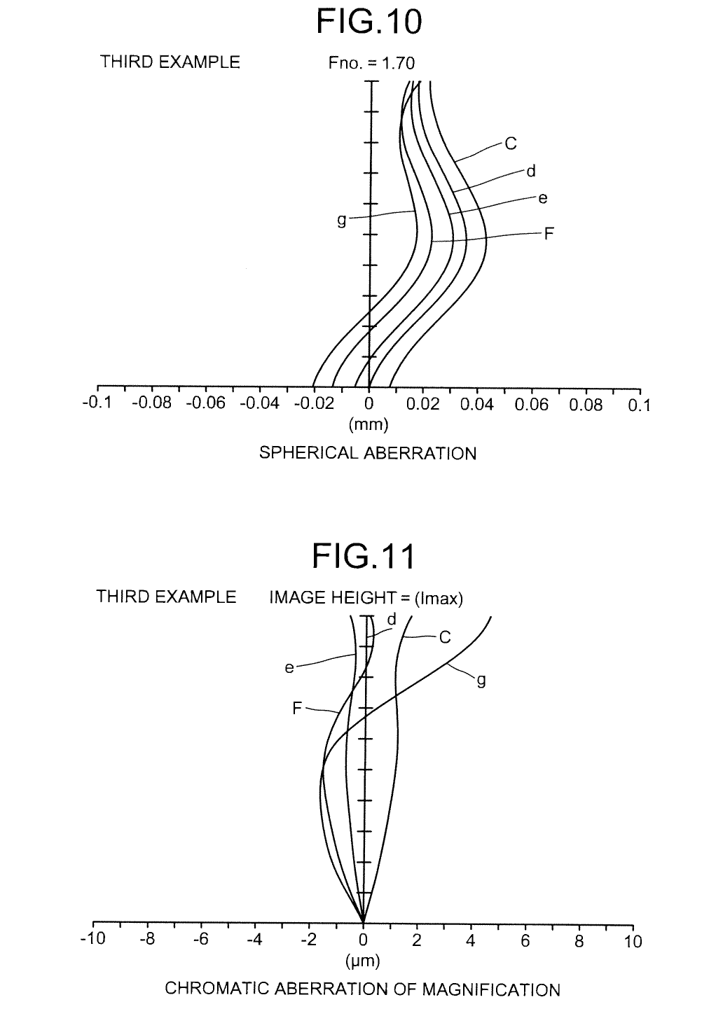

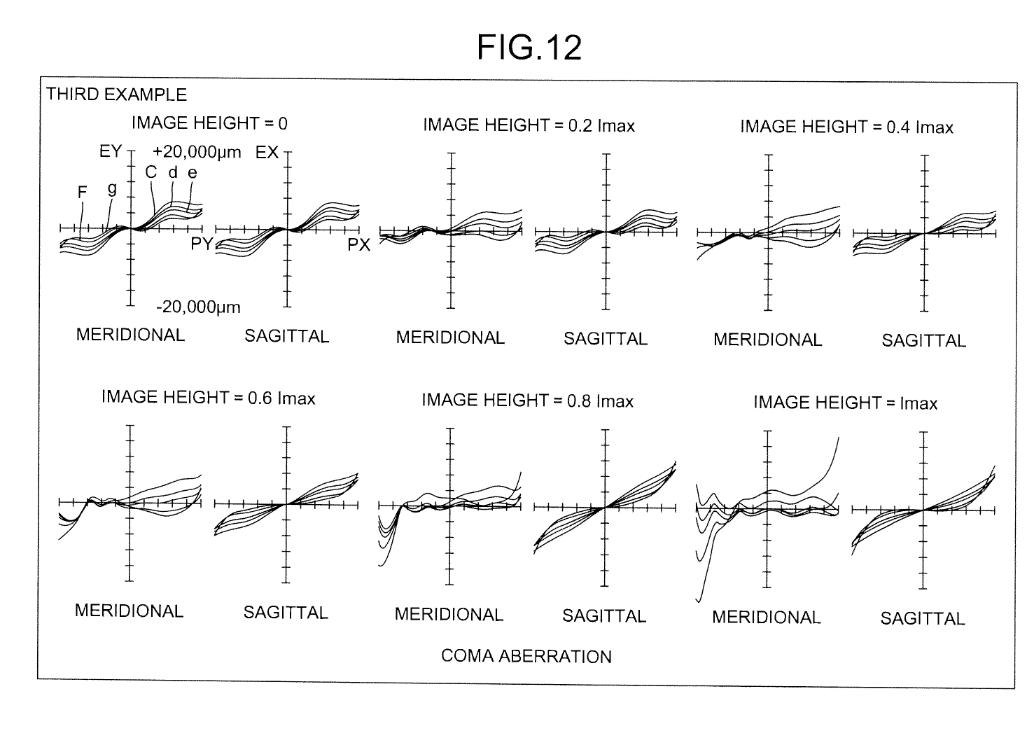

FIG. 10 is a schematic of spherical aberration of the wide angle lens according to the third example. FIG. 11 is a schematic of chromatic aberration of magnification of the wide angle lens according to the third example. FIG. 12 is a schematic of coma aberration of the wide angle lens according to the third example. In the schematics, d indicates wavelength aberration corresponding to the d-line (λ=588 nm), g indicates wavelength aberration corresponding to the g-line (λ=436 nm), F indicates wavelength aberration corresponding to the F-line (λ=486 nm), C indicates wavelength aberration corresponding to the C-line (λ=656 nm), and e indicates wavelength aberration corresponding to the e-line (λ=546 nm). Iₘₐₓ in the schematics of chromatic aberration of magnification and coma aberration represents the maximum image height.

Among the values above, r₁, r₂, . . . represent the radii of curvature of the lenses; d₁, d₂, . . . represent the thickness of the lenses, diaphragm, etc. or the distance between surfaces thereof; nd₁, nd₂, represent the refraction index of the lenses with respect to the d-line (λ=588 nm) thereof, υd₁, υd₂, . . . represent the Abbe value at the d-line of the lenses.

The aspheric surfaces above are expressed by the equation below, where X is the sag of the aspheric surface from the intersection with the optical axis; H is the distance from the optical axis toward an outer dimension of the lens; and the direction of travel of light is assumed to be positive.

$$X = \frac{{H}^{2} / R}{1 + \sqrt{1 - ( ɛ {H}^{2} / {R}^{2} )}} + {AH}^{2} + {BH}^{3} + {CH}^{4} + {DH}^{5} + {EH}^{6} + {FH}^{7} + {GH}^{8} + {IH}^{9} + {JH}^{10} + {KH}^{11} + {LH}^{12} + {MH}^{13} \qquad [ 1 ]$$

Where, R is paraxial radius of curvature; ε is the constant of the cone; and A, B, C, D, E, F, G, I, J, K, L, and M are the second, third, fourth, fifth, sixth, seventh, eighth, ninth, tenth, eleventh, twelfth, and thirteenth aspheric coefficients, respectively.

As described, the configurations in the examples above enable the realization of a compact wide angle lens that achieves the brightness of an F value on the order of 1.7 and a field of view of 200 degrees or more, and has high imaging performance over the entire effective imaging area. In particular, the wide angle lens is excellent in correcting chromatic aberration of magnification and coma aberration occurring at the peripheral image height. Furthermore, by incorporating an aspheric lens as necessary, in addition to chromatic aberration of magnification and coma aberration, other types of aberration such as spherical aberration can be corrected.

According to the embodiment, a compact wide angle lens can be provided that in addition to bright, wide angle images, provides high imaging performance over the entire effective imaging area.

As described, the wide angle lens according to the invention is useful for electronic imaging apparatuses equipped with an imaging device and is particularly, suitable for monitoring cameras, which must capture wide angle views and images in dimly lit places.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2010-256885 filed in Japan on Nov. 17, 2010.

What is claimed is:

1. A wide angle lens comprising, sequentially from an object side:
a first lens group having a negative refractive power;
an aperture stop; and
a second lens group having a positive refractive power, wherein
the first lens group comprises four or more lenses, and
the second lens group comprises four or more lenses, among which a lens farthest on an image side of the second lens group is a negative lens.

2. The wide angle lens according to claim 1, wherein the negative lens farthest on the image side of the second lens group has a concave surface on the image side.

3. The wide angle lens according to claim 2, wherein a lens second farthest on the image side of the second lens group is a positive lens.

4. The wide angle lens according claim 1, wherein conditional expressions (1) AB1<AB2 and (2) AB1<45 are satisfied, where AB1 represents an Abbe number at a d-line of the lens farthest on the image side of the wide angle lens and AB2 represents the Abbe number at the d-line of a lens second farthest on the image side of the wide angle lens.

5. The wide angle lens according to claim 1 wherein a conditional expression (4) 15<θ (0.7Iₘₐₓ)<30 is satisfied, where θ (0.7Iₘₐₓ) represents an incident angle of the chief ray to an imaging surface and forming an image at a position 70% of a maximum image height Iₘₐₓ.

6. A wide angle lens comprising, sequentially from an object side:
a first lens group having a negative refractive power;
an aperture stop; and
a second lens group having a positive refractive power, wherein
the first lens group comprises sequentially from the object side:
a negative first lens having on the object side, a convex surface,
a negative second lens having on an image side, a concave surface,
a negative third lens, and
a positive fourth lens, and
the second lens group comprises sequentially from the object side:
a cemented lens having a positive refractive power and formed by a fifth lens and a sixth lens,
a positive seventh lens, and
a negative eighth lens having on the image side, a concave surface.

7. The wide angle lens according claim 6, wherein conditional expressions (1) AB1<AB2 and (2) AB1<45 are satisfied, where AB1 represents an Abbe number at a d-line of the lens farthest on the image side of the wide angle lens and AB2 represents the Abbe number at the d-line of the lens second farthest on the image side of the wide angle lens.

8. The wide angle lens according to claim 6 wherein a conditional expression (4) 15<θ (0.7Iₘₐₓ)<30 is satisfied, where θ (0.7Iₘₐₓ) represents an incident angle of the chief ray to an imaging surface and forming an image at a position 70% of a maximum image height Iₘₐₓ.

9. A wide angle lens comprising sequentially from an object side:
a first lens group having a negative refractive power;
an aperture stop; and
a second lens group having a positive refractive power, wherein
the first lens group includes four or more lenses,
the second lens group includes four or more lenses, among which a lens farthest on an image side of the second lens group has on the image side of the lens, an aspheric surface that satisfies a conditional expression (3) X(0.7H)>0, where,
$$X = \frac{{H}^{2} / R}{1 + \sqrt{1 - ( ɛ {H}^{2} / {R}^{2} )}} + {AH}^{2} + {BH}^{3} + {CH}^{4} + {DH}^{5} + {EH}^{6} + {FH}^{7} + {GH}^{8} + {IH}^{9} + {JH}^{10} + {KH}^{11} + {LH}^{12} + {MH}^{13}$$
X is sag (direction of image plane assumed as positive) of the aspheric surface from an intersection with an optical axis; H is a distance from the optical axis toward an outer diameter of the lens; R is paraxial radius of curvature; ε is the constant of the cone; A, B, C, D, E, F, G, I, J, K, L, and M are the second, third, fourth, fifth, sixth, seventh, eighth, ninth, tenth, eleventh, twelfth, and thirteenth aspheric coefficients, respectively; X(0.7H) represents the aspheric surface sag at a position 70% of the distance H from the optical axis center with respect to the effective diameter of the surface on the image side of the lens farthest on the image side of the second lens group.

10. The wide angle lens according to claim 9 wherein a conditional expression (4) 15<θ (0.7Iₘₐₓ)<30 is satisfied, where θ (0.7Iₘₐₓ) represents an incident angle of the chief ray to an imaging surface and forming an image at a position 70% of a maximum image height Iₘₐₓ.
